(19) United States
(12) Patent Application Publication
(10) Pub. No.: US 2009/0150386 A1
(43) Pub. Date: Jun. 11, 2009

(54) SYSTEMS AND METHODS FOR LINKING AND COMMUNICATIONS BETWEEN EMPLOYERS AND EMPLOYEES

(76) Inventor: Perry LICHTBLAU, Thornhill (CA)

Correspondence Address: Ralph A. Dowell of DOWELL & DOWELL P.C., 2111 Eisenhower Ave, Suite 406, Alexandria, VA, 22314, US

(21) Appl. No.: 12/263,218

(22) Filed: Oct. 31, 2008

Related U.S. Application Data
(60) Provisional application No. 60/984,481, filed on Nov. 1, 2007.

(51) Int. Cl. G06F 17/30

(52) U.S. Cl. 707/5; 707/E17.071

(57) ABSTRACT

Systems and methods for linking and communications between employers and employees are described. In an aspect there is a system and method for setting up an interview with an employee through a web-based interface is described. Employee information is stored in a database that can be searched by employees who have registered to use the system. A web-based search engine provides search results to the employer based upon the specific criteria inputted by the employer. The employer is provided with virtual tokens through an account maintained by the system that are used as payment to the system if an employer contacts an employee for an interview. The employer requests an interview with the employee by sending a request for interview through a communication system. The employer accepts the request and is provided with the employee's contact information so that an interview may be initiated. After an interview, the employer provides an offer to hire to the employee through a communication system. The invention further comprises methods and systems of tracking advertising information of a business by recording the number of persons who view website-based advertising materials or information contained in electronic newsletters and relaying this information back to the business.

This application claims the benefit of U.S. provisional patent application Ser. No. 60/984,481 filed Nov. 1, 2007 and entitled SYSTEMS AND METHODS FOR ADVERTISING, HIRING, LINKING EMPLOYERS AND EMPLOYEES, The entire contents of which are hereby incorporated by reference.

### BACKGROUND OF THE INVENTION

The invention in certain aspects relates to systems and methods for advertising, searching, interviewing, hiring and linking employers and employees, as well as systems and methods for tracking advertising information in a computerized system. In certain aspects, the invention relates to a computerized management and payment system to facilitate the hiring of an employee by an employer. The system can be adapted for use in a particular professional field.

### SUMMARY OF THE INVENTION

In various aspects the invention provides systems and methods for advertising, searching, interviewing, hiring, and linking employers and employees.

In an aspect, there is a method of operating a computer-based payment system for an employer searching for an employee. The method comprises: receiving from the employee employment information and contact information through a web-based interface, and storing the employment information and contact information into a record in a database of the system; registering the employer for use of the system, and providing virtual tokens to the employer through an account maintained by the system for the employer in relation to payments made by the employer for the virtual tokens; permitting the employer to conduct a search of the employment information in the database by inputting search criteria into a web-based search engine of the system; providing search results from the web-based search engine to the employer based on the search, the search results including at least a portion of the employment information of the record associated with the employee, but excluding the contact information of the record associated with the employee; permitting the employer to request an interview with the employee by so indicating in relation to the record associated with the employee in the search results, the request including sending a request for interview to the employee; receiving from the employee an acceptance to the request for interview; providing the employer with an indication of the acceptance to the request for interview; providing the employer with the contact information of the record associated with the employee; and deducting one or more tokens from the account of the employer.

The employment information and the search criteria may each include: a description of the professional experience of the employee; a city of residence of the employee; languages spoken by the employee; an hourly rate of the employee; and times at which the employee is available for work.

The method may further comprise receiving an indication that the employer has confirmed a time and date of an interview with the employee before deducting the one or more tokens from the account.

The method may further comprise: receiving an offer to hire the employee from the employer; providing the offer to hire to the employee; receiving an acceptance of the offer from the employee; and providing to the employee a gift certificate. The method may further comprise providing a specific time frame in which the employee must respond to the request for interview, and a specific time frame in which the employee must respond to the offer to hire.

The virtual tokens of the employer may be replenished upon the employer adding funds in relation to the account maintained by the system. The funds may be added in relation to the account are non-refundable and non-transferable. The offer to hire may be for any one of a emergency position of employment, a temporary position of employment, a permanent position of employment, a part time position of employment and full time position of employment. The employer and the employee may be involved with a professional industry. The professional industry may be a dental industry.

In another aspect, there is method for setting up an interview with an employee using a computer-based system. The method comprises: receiving from the employee employment information and contact information through a web-based interface, and storing the employment information and contact information into a record in a database of the system; receiving a search request from an employer based on search criteria entered by the employer into a web-based search engine of the system; providing search results from the web-based search engine to the employer based on the search, the search results including at least a portion of the employment information of the record associated with the employee, but excluding the contact information of the record associated with the employee; permitting the employer to request an interview with the employee by so indicating in relation to the record associated with the employee in the search results, the request including sending a request for interview to the employee through a communication system associated with the computer system; receiving from the employee an acceptance to the request for interview; providing the employer with an indication of the acceptance to the request for interview; providing the employer with the contact information of the record associated with the employee; and permitting the employer to enter interview information relating to the time and place of the interview into the system, and sending the interview information to the employee through the communication system.

The employment information and the search criteria may each include: a description of the professional experience of the employee; a city of residence of the employee; languages spoken by the employee; an hourly rate of the employee; and times at which the employee is available for work.

The method may further comprise: receiving an offer to hire the employee from the employer; providing the offer to hire to the employee; receiving an acceptance of the offer from the employee; and providing to the employee a gift certificate. The method may further comprise providing a specific time frame in which the employee must respond to the request for interview, and a specific time frame in which the employee must respond to the offer to hire.

The offer to hire may be for any one of a emergency position of employment, a temporary position of employment and a permanent position of employment, full time position or part time position; The employer and the employee may be involved with a professional industry, and the professional industry may be a dental industry.

In yet another aspect, there is a method for tracking advertising information in a computerized system accessible via the Internet. The method comprises: posting advertising materials for a business on an Internet website associated with the computerized system, the materials including a business logo, business description and website hyperlinks associated with the business; providing access to the website to the public, and tracking advertising information, including a number of members of the public who views the advertising materials; recording the traded advertising information and providing the information to the business through an electronic registration authenticated for access by the business or a person authorized by the business.

The method may further comprise additionally tracking marketing information associated with an electronic newsletter. A subscriber of the newsletter may identify areas of interest in advertising material displayed in the electronic newsletter by selecting appropriate hyperlinks to websites displayed in the electronic newsletter. The system record and submit the areas of interest selected by the subscriber to the business. The system may be receiving additional advertising materials from the business relating to the areas of interest selected by the subscriber. The system may send a message to the subscriber from the business that provides at least one of (i) the additional advertising materials or (ii) a electronic Internet link to the additional advertising materials.

The subscriber may be involved with a professional industry. The professional industry may be dental industry. The advertising material may be related to the professional industry. The advertising material may be related to the dental industry.

In other aspects, there are apparatus, systems and/or computer programming relating to the foregoing.

### BRIEF DESCRIPTION OF THE DRAWINGS

The foregoing and other aspects of the invention will become more apparent from the following description of specific embodiments thereof and the accompanying drawings which illustrate, by way of example only, the principles of the invention. In the drawings, where like elements feature like reference numerals (and wherein individual elements bear unique alphabetical suffixes).

FIG. 1a is a screen printout of a system access screen in an exemplary embodiment of the invention;

FIG. 1b is a screen printout of a login screen to the system of FIG. 1;

FIG. 2a is a screen printout showing an exemplary search input screen in the system of FIG. 1;

FIG. 2b is a screen printout showing a screen of an exemplary set of search results from the search input screen of FIG. 2a;

FIGS. 2c and 2d are screen printouts showing screens for a selected exemplary record from the screen of FIG. 2b;

FIG. 3 is a screen printout showing an exemplary listing in the system of FIG. 1;

FIG. 4 is a screen printout showing a further exemplary listing in the system of FIG. 1;

FIG. 5a is a screen printout showing an exemplary account registration and information screen; and

FIG. 5b to 5d are screen printouts showing further exemplary information that can be provided for a user.

### DETAILED DESCRIPTION OF THE PREFERRED EMBODIMENTS

The description which follows, and the embodiments described therein, are provided by way of illustration of an example, or examples, of particular embodiments of the principles of the present invention. These examples are provided for the purposes of explanation, and not limitation, of those principles and of the invention.

In an embodiment of the present invention, there are systems and/or methods of generating a computer-based payment system for an employer and an employee that facilitates the hiring of an employee by an employer. In other embodiments, systems and methods are provided for tracking interest in displayed advertising material that can be posted on a website. In still other embodiments, a pre-paid account can be generated by an employer and maintained by a website operator in order to deduct the fees associated with the use of the system(s). In an embodiment, the systems and method are targeted to a specific professional industry, such as the dental industry.

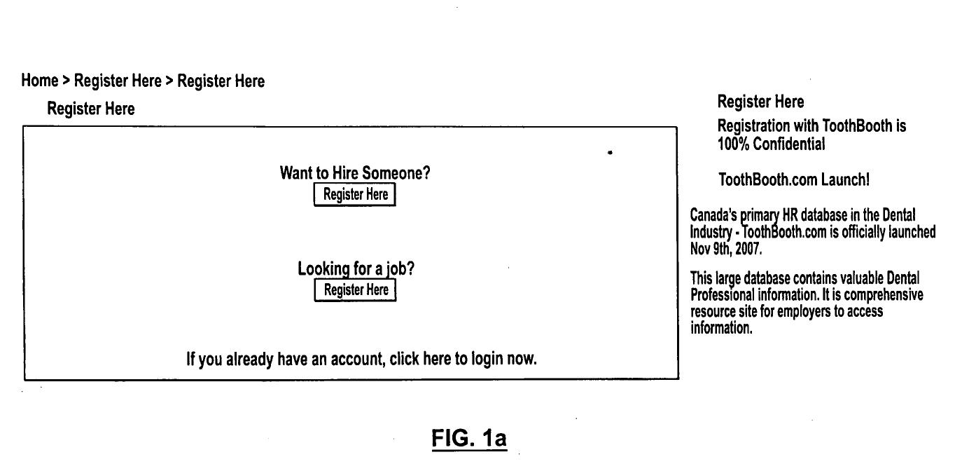

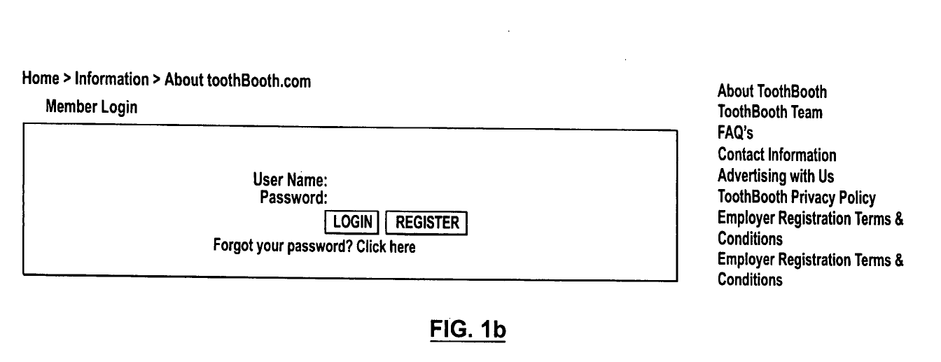

In an embodiment, there is a computerized system for access by various users by various communication methods or devices, such as through the internet. For example, users of the system can register for a user account with a website that is maintained by a website operator for the system, and each user of the website can have an individualized login page. Referring to FIG. 1a for example, the system can provide a web portal for a user to register as a prospective employer or employees, and the user can register as looking to hire someone (employer) or looking for a job (employee). For ease of reference, the terms “employers” and “employees” refers to both actual and potential or prospective employers and employees. After a user is registered, he or she can log-in to the system via a log-in screen, such as shown in FIG. 1b. Users can be prompted to enter a unique login identification in order to access a secure user account. A password may be generated by the system or chosen by the user that must be entered into the system to permit access to the secure user account.

Once a user account is generated by the computer system, users who are employees can input information to generate a personal profile associated with the account. The system can store various personal information about the user including employment information and contact information. Contact information can include user name, address, telephone number, facsimile number and email address, while employment information can include current employment, employment skills, languages spoken, time at which the employee is availability for employment and hourly rate (and/or requested salary or wage) for employment. As will be described in greater detail below, the employment information does not include any information that allows a party to contact the user (i.e., the contact information). The personal information of a user may be modified by the user after the user has logged into the account. The user's password can also be modified by the user, or in another embodiment, the user's unique login name and password can be modified. User's who are employers can also input information to create an employer profile associated with the user's account.

Each personal profile, including the personal information described above, can be stored in a unique record within the system that is linked to the user's account that generated the profile. The records are complied into a database and maintained by a website operator for the system. In different embodiments, the profiles of users who are employees can be maintained in a separate database from the profiles of users who are employers. The records and database(s) may be stored in one or more locations.

In one aspect of the invention, the profiles of users may be further categorized within a searchable database. For example, the profiles may be categorized by professional industry, such as the dental industry or legal industry. The database can be searched by a user by limiting the search to profiles categorized under a particular professional industry.

In an embodiment, employers can purchase/obtain an annual membership fee, purchase/obtain a set of virtual tokens, and/or purchase/obtain unlimited virtual tokens for accessing detailed contact information for employees as more fully described below. These virtual tokens and membership can be offered as complementary in an advertising campaign, or can be paid for through the generation of a pre-paid account that can, for example be maintained by the website operator or another organization associated therewith. As tokens are used up, users can obtain new tokens by paying a further amount at currently set prices.

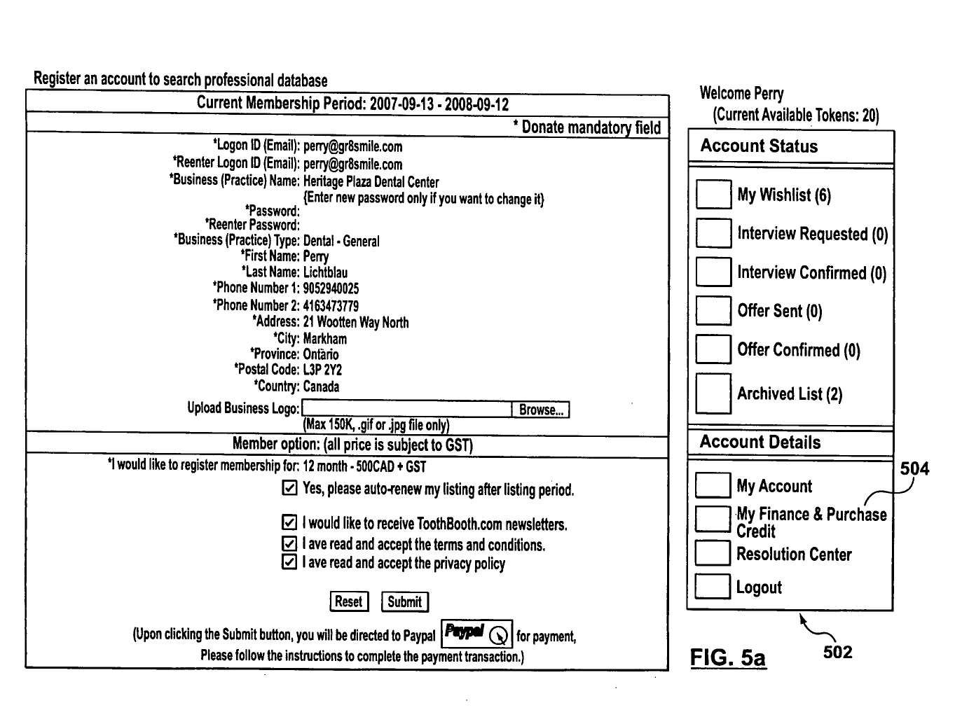

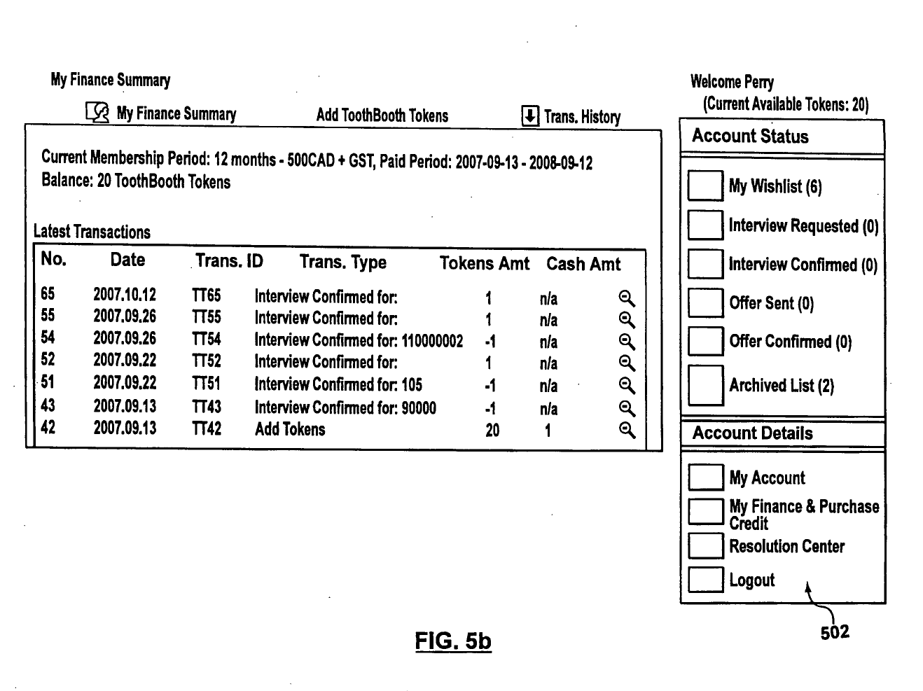

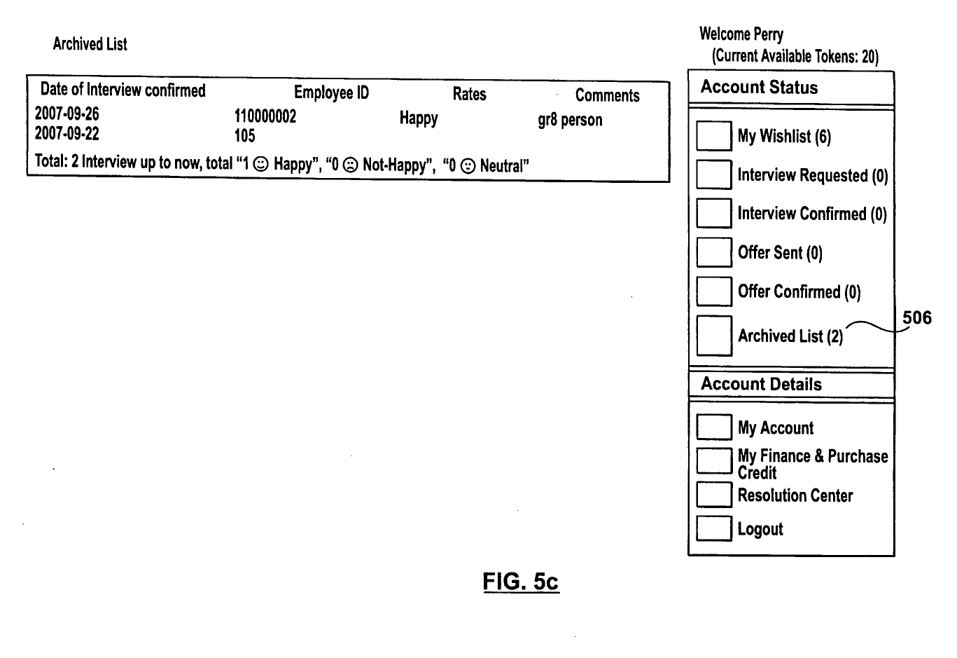

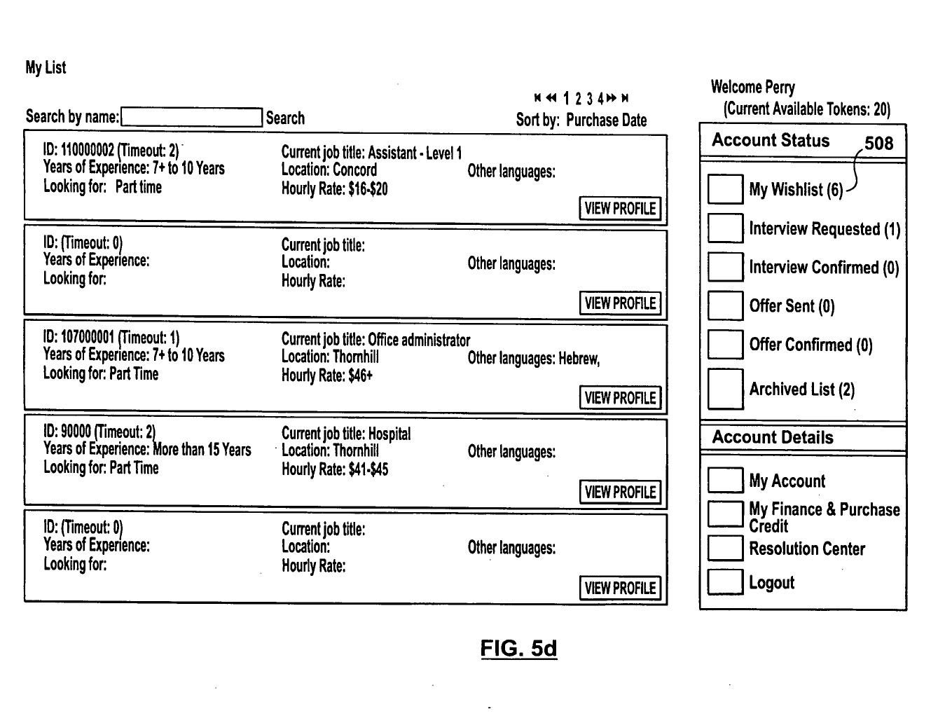

For example, when an employer user sets up an account, it can do so via a screen such as shown in FIG. 5a. Once an account is set up and the user is logged in, a sidebar panel 502 provides a number of selectable options to the user, including selection 504 to show token and credit information. If 504 is selected, a screen such as shown in FIG. 5b is displayed, on which transaction details relating to tokens can be displayed. The employer user can then purchase additional tokens via entering credit card information into the system or by other payment options.

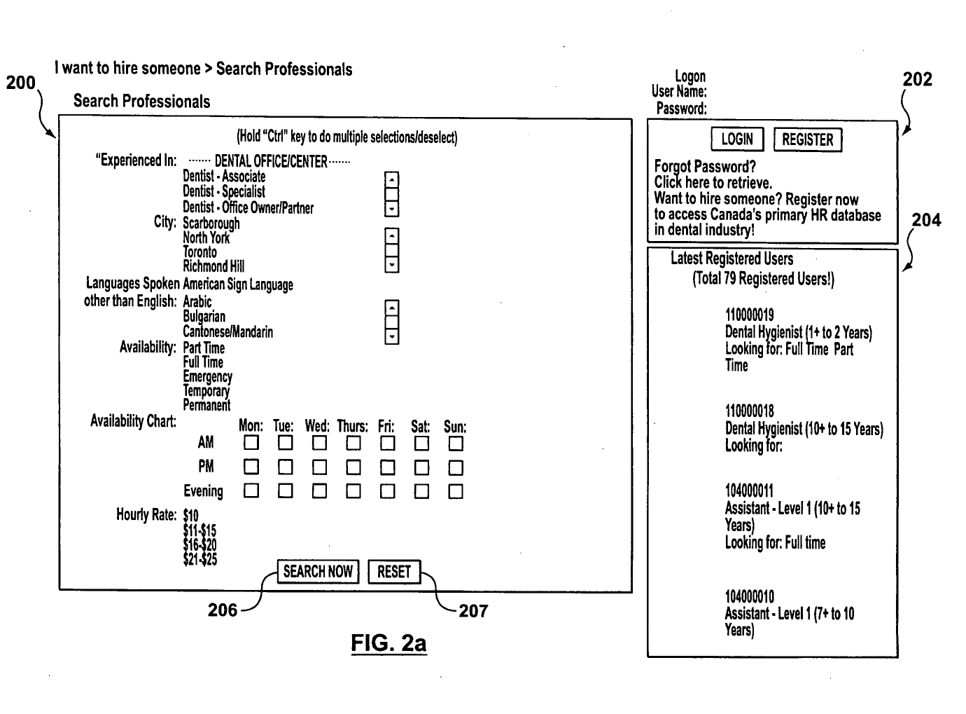

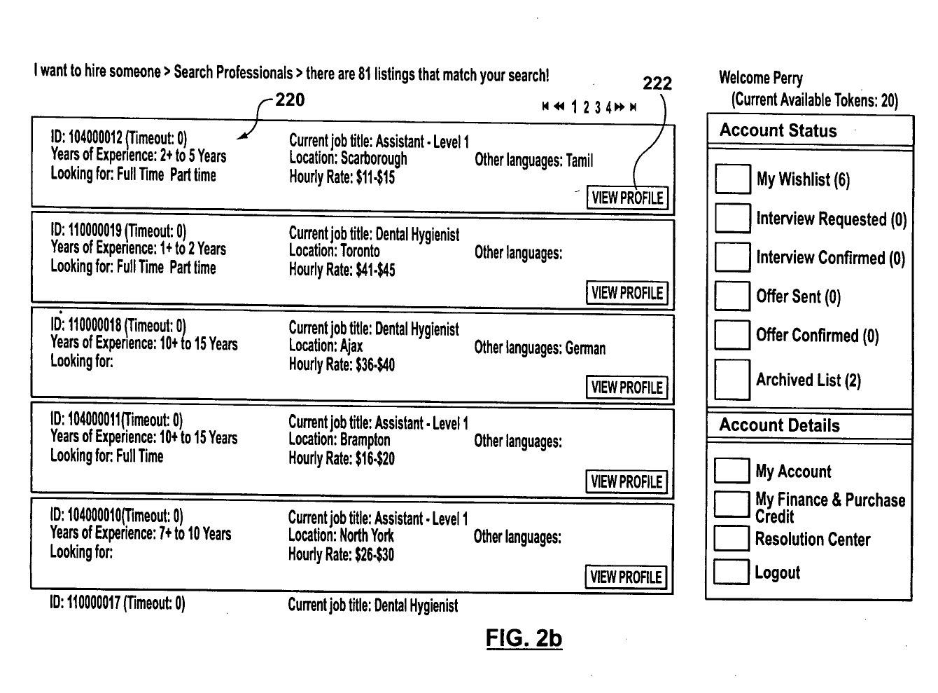

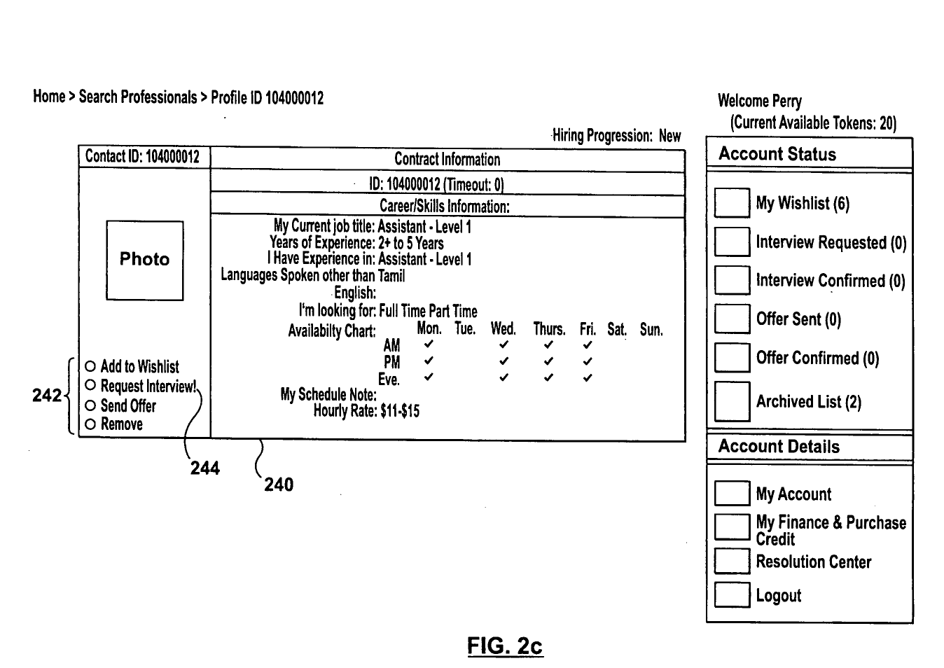

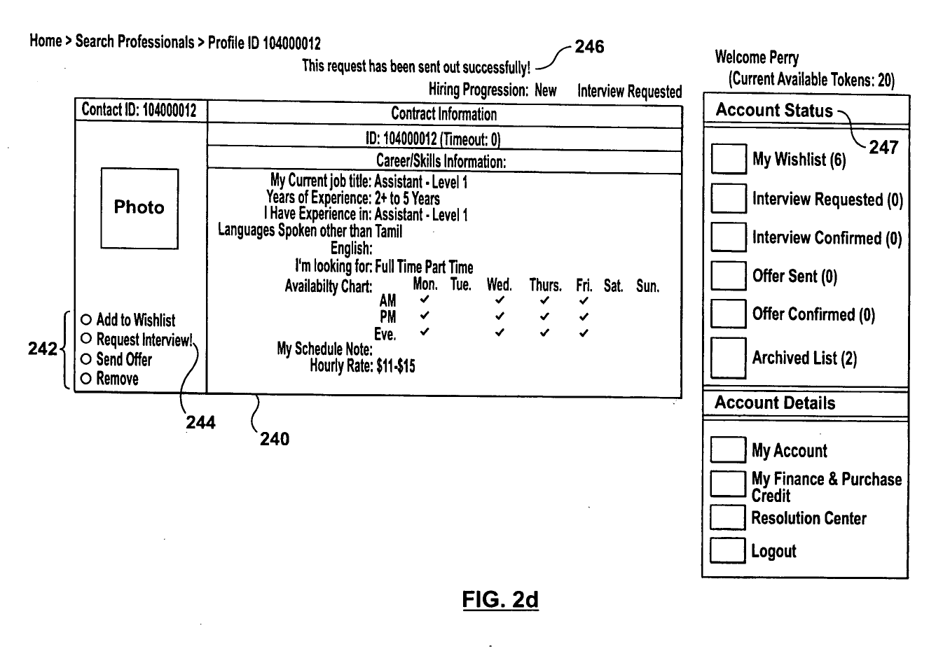

The virtual tokens purchased by an employer are utilized in connection with the search functions of the system. The search function enables an employer to identify, and contact, a suitable employee for an interview an/or an offer to hire for employment. Referring to FIG. 2a, there is an exemplary search screen in which exemplary criteria for searching for employees in the dental industry are shown in area 200. As shown, a user can also log-in to the system in area 202 of this screen. Furthermore, area 204 can be provided to show excerpted information for prospective employers and/or employees. A varying level of detail in information can be provided in area 200 and 204 as determined by the system.

In the case where a user is an employer, after logging into the user account, the user can access a search screen as displayed in area 200. Using this search screen, the employer can select certain criteria in order to search employee profiles stored in a database. The searches conducted by the employer can be very specific, in that one can search based upon specific features of an employee including professional experience of the employee; city of residence of the employee, languages spoken by the employee, hourly rate of the employee and availability for work of the employee. Exemplary search criteria are shown in FIG. 2a. As shown in area 200, the system may have pre-set options for the employee search criteria that are selected my the user. The employer may also manually enter search criteria by typing criteria into specified areas on the search screen. The employer may select as few or as many options as desired in order to modify the search results that will be displayed after a search of the employee profiles in the employee database is performed by the system. The search results can be narrowed as more options are selected by the employer. The user can clear the selected criteria at any time via a reset button 207 and re-enter the desired criteria.

Once an employer has entered search criteria into the search screen, the employer can submit the criteria to the system via a search button 206 as shown in FIG. 2a. The system can search the stored employee personal profiles and display records that match the specific inputted criteria. The matching results are displayed to the user on the computer screen as shown for example in FIG. 2b. A number matching entries or records for different employees can be shown on a single screen. The system may indicate the total number of records that were retrieved from the search. If no records were retrieved in the search, the system may prompt the employer to modify the search criteria and perform an additional search of the employee records.

In an embodiment, the name of the employee associated a matched record is not displayed to the employer so that potential employees are anonymous to the employer at this stage. Each matching record has its own unique identifier that connects the record to the personal profile of an employee, such as record 220 shown in FIG. 2b.

The employer may obtain additional details for a record 220 by selecting button 222, which can lead to display of a further screen such as shown in FIG. 2c. In FIG. 2c, there is shown record details 240 that provide more personal and employment information regarding record 220 and an employee associated therewith. In an embodiment, only employment information is searched as above, and contact information of the employee is not displayed to the employer on this display screen. In different embodiments, various aspects of the personal information in a record associated with a user employee, or employees, may be displayed at different times.

The employer may save and store suitable matching records in a virtual “filing cabinet” associated his or her user account within the system. This enables the employer to easily retrieve previously searched employee information at a later time without having to research the database. The stored matching records can be accessed by the employer by display of a hyperlink on the display screen that leads to a display of the information stored in the “filing cabinet”.

Upon receiving search results based on the specific search parameters as entered, the employer can choose to interview particular prospective employees by hitting or pressing a “Request Interview” button (such as 244 in FIG. 2c) that can be provided by the system to the employer's computer screen, such as provided through the website. The pressing of this button causes the system to send an automated email notification to the particular prospective employee(s) about the interview request. Referring to FIG. 2c, record details 240 include action selections 242 that allow a searching employer to perform certain actions, including requesting an interview with the employee associated with the matched record through selection 244. For example, upon selecting 244, a request to interview the particular employee can be sent, such as via a system generated e-mail, to the employee by the system, and confirmation of sending such request can be displayed to the employer, such as via 246 shown in FIG. 2d.

The employee associated with the record can receive the system generated email sent via the employer's account. The employee can log into his or her personal user account to review the request for interview generated by the system. The employee may choose to accept or to decline the request for interview by way of activating hyperlink buttons displayed in an account notification area on the computer screen. A system generated email can be sent to the employer who requested the interview that indicates whether the request has been accepted or declined by the employee.

If the request for an interview is accepted, the employer can be sent an automated email notification confirming the acceptance of the interview. One or more virtual token(s) may then be removed from the employer's account with the system operator. In an embodiment, once the token(s) have been removed from the employer's account, the system then permits the employer to view the contact information associated with the employee from the employee's database record, so that the employer is now able to, among other things, initiate a personal interview with the employee. The employer can receive an email notification to log-in to his or her account and view the employee contact information that has been released by the system. The employee contact information may include the employee's name, telephone number and email address.

The employer may contact the employee to set up an interview by phone or via a system generated email. In certain embodiments, an electronic messaging system can be provided with the web system to facilitate communication between users. In other embodiments, the web system can be associated with other communication systems, including email and/or SMS.

In one embodiment, the system may include a “time-out” counter to measure an employee's responsiveness history. This “time-out” feature can be considered by employers prior to requesting an interview with a certain employee. For example, if an employer contacts an employee to initiate an interview, but no response is received from the employee within a certain time frame, the employer may indicate via a hyperlink on the system account page that the particular employee failed to respond. This “time-out” can be recorded in the employee's personal profile by the system and be displayed to subsequent employers who retrieve the employee record in a search. The time period for responding to an employer can be for example within 7 business days subsequent to an employer submitting a request for an interview to the employee.

After an interview, which can be conducted between the employee and employer via voice-over-IP, message chat and/or video conferencing offered through the system or via phone or face-to-face communication, the employer can send an “offer to hire” to any interviewed employees by pressing a button displayed on the computer screen by the system after logging into his or her account. The offer to hire can be sent via an email or other communication system, including SMS and/or other wired or wireless systems. The employee can also accept the offer to hire using the same system, an electronic mail system, or via other contact with the employer. A “time-out” counter can be associated with the system to measure the employee responsiveness to an offer to hire as described above. The time period for responding to an offer to hire can be for example within 48 hours after the offer is sent by the employer through an email notification through the system.

In one embodiment, once an employee submits an acceptance to an interview request or an acceptance to an offer to hire, a system generated notification can be sent to the employee that contains a gift certificate entitlement as a reward for using the system. The notification may include a secret code from the system that can be used to download a gift certificate from a merchant specified by the website operator.

The system can include an account status sidebar as shown in area 247 of FIG. 2d. The sidebar can display various information that is specific to the users account, such as the number of tokens available, the number of interviews requested, the number of interviews confirmed, the number of offers sent and the number of offers confirmed. Hyperlinks displayed on the screen and be utilized by the user to access this additional information that is maintained by the system.

In one embodiment, the system can maintain and display additional information to a user such as the information displayed in FIG. 5c. For example, if button 506 is selected, a display such as shown in FIG. 5c can be shown in which archived interview information is displayed. The user can rate the interview to indicate whether he or she was satisfied with the employee interview. This information can be linked to an employee record and displayed to an employer when he or she retrieves and reviews search results.

FIG. 5d shows another example of additional information that can be maintained and displayed by the system. For an example, if button 508 is selected, a display such as shown in FIG. 5d can be shown to the user in which a “wishlist” of employees, or other equipment or business buy/sell opportunities wished for by a user can also be displayed. This allows a user to keep track of searches that have been performed by the system.

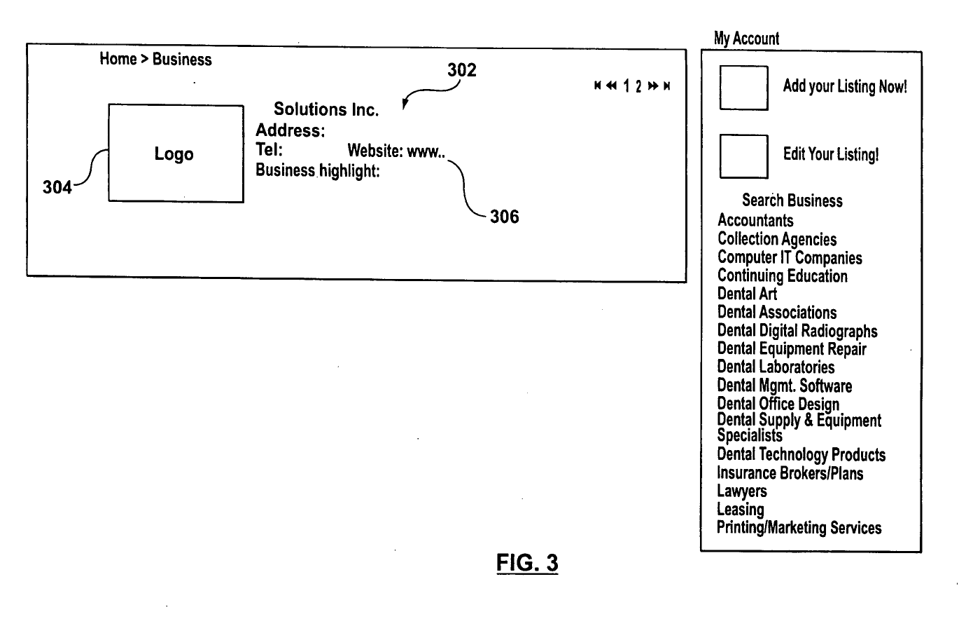

In another aspect of the invention, there is a website based business directory service, such as shown in FIG. 3. This area of the system can be fee-based for the posting of advertising materials, but can also be free for members of the public to view and participate in certain embodiments. The business directory can be a virtual location for business advertising that can be aimed towards members of a particular industry, including the dental industry or legal industry. The advertising can be aimed at the users of the employee search database system described above.

Businesses who want to post advertising material to the business directory can be provided with three different advertising options, that can be made available at differing costs. For example, one advertising option/level is to place a business logo 304 and business description with a hyperlink to the advertising company's own website 306. Another advertising option/level is to place two counters on the advertisers' login page, that can be invisible to the general public, which counts the number of times a unique member of the public clicks on the advertiser's advertisement and/or the number of times a unique member of the public clicks the hyperlink to the advertising company's own website.

Yet another advertising option/level involves advertising and marketing features. For example, the website operator can provide feedback marketing through electronic newsletters that participating advertisers have signed up to receive. The website operator can provide a separate co-branded newsletter template for a participating business which provides the unique information that would be of interest to members of the public who can view the advertisements posted in the business directory. The newsletter can include keywords in it that allow the website operator to track areas of interest to viewers of posted advertisements. The website operator can also report to an advertiser company various types of marketing information. This marketing information may consist of an analysis of the number of hits popularity for various services or products and/or a breakdown of who is interested in those products and services by providing the advertiser with names and emails of persons who viewed the advertisement.

For example, in FIG. 3, an advertising listing 302 is provided for the notional business “Solutions Inc.”. For this exemplary listing, there is shown an associated business logo 304 and other information relating to the business, such as address, telephone, website and business highlights.

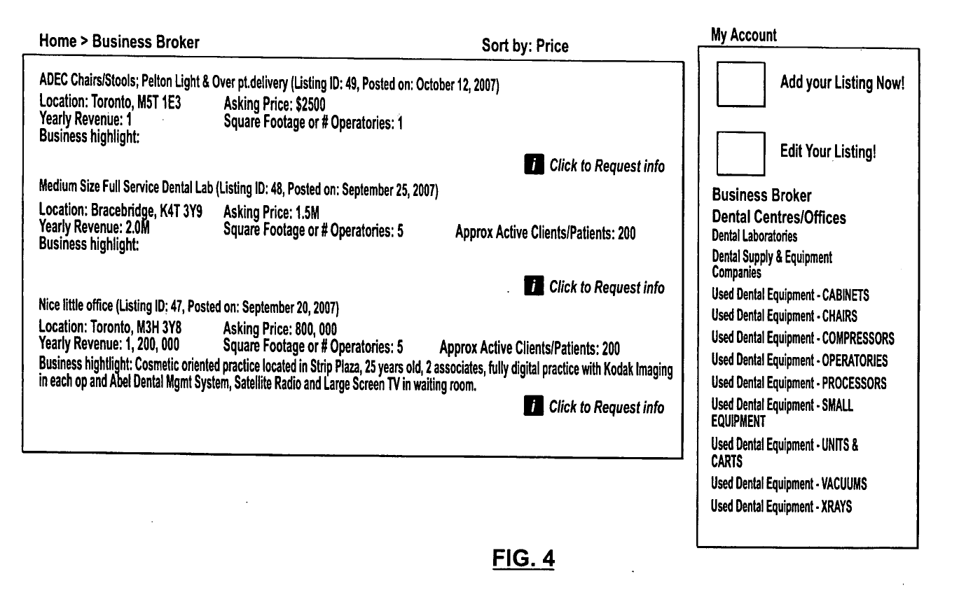

Another aspect of the invention provides website-based buy/sell business area, such as shown in FIG. 4. The use of this buy/sell business area can be fee-based for listings of businesses on the web system, but can be free for members of the public to view and participate in certain embodiments. The business area can allow businesses to list a business for sale without the use of a broker. Potential buyers can click a link requesting a meeting or more information directly from the seller. These negotiations between buyers and sellers can be conducted independently of a website operator, but may also be connected through chat, video-conferencing or other communications over the system.

Still another aspect of the invention provides a website-based used equipment area to the systems and methods. The use of this used equipment area can be fee-based for the listings of used equipment for sale but can be free for members of the public to view and participate. This area also allows businesses to post used equipment for sale on the web system. The process of purchasing such equipment can be similar to the buy/sell business area, but can be configured to provide more details with respect to the items that can be listed. This area can include photos of the equipment that can be uploaded by the seller for a potential buyer to view.

As will be understood by those of ordinary skill in the relevant arts, once they have been made familiar with this disclosure, a wide variety of different software and hardware aspects can be utilized to implement the systems and methods described in this disclosure. The details of such software and hardware aspects are therefore not described in further detail.

While the foregoing invention has been described in some detail for purposes of clarity and understanding, it will be appreciated by those skilled in the relevant arts, once they have been made familiar with this disclosure, that various changes in form and detail can be made without departing from the true scope of the invention in the appended claims. The invention is therefore not to be limited to the exact components or details of methodology or construction set forth above. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

We claim:

1. A method of operating a computer-based payment system for an employer searching for an employee, comprising:
receiving from the employee employment information and contact information through a web-based interface, and storing the employment information and contact information into a record in a database of the system;
registering the employer for use of the system, and providing virtual tokens to the employer through an account maintained by the system for the employer in relation to payments made by the employer for the virtual tokens;
permitting the employer to conduct a search of the employment information in the database by inputting search criteria into a web-based search engine of the system;
providing search results from the web-based search engine to the employer based on the search, the search results including at least a portion of the employment information of the record associated with the employee, but excluding the contact information of the record associated with the employee;
permitting the employer to request an interview with the employee by so indicating in relation to the record associated with the employee in the search results, the request including sending a request for interview to the employee through a communication system associated with the payment system;
receiving from the employee an acceptance to the request for interview;
providing the employer with an indication of the acceptance to the request for interview;
providing the employer with the contact information of the record associated with the employee; and
deducting one or more tokens from the account of the employer.

2. The method of claim 1, wherein the employment information and the search criteria each include: a description of the professional experience of the employee; a city of residence of the employee; languages spoken by the employee; an hourly rate of the employee; and times at which the employee is available for work.

3. The method of claim 2, further comprising receiving an indication that the employer has confirmed a time and date of an interview with the employee before deducting the one or more tokens from the account.

4. The method of claim 3, further comprising;
receiving an offer to hire the employee from the employer;
providing the offer to hire the employee; and
receiving an acceptance of the offer from the employee.

5. The method of claim 4, further comprising providing to the employee a gift certificate.

6. The method of claim 5, further comprising providing a specific time frame in which the employee must respond to the request for interview.

7. The method of claim 6, further comprising providing a specific time frame in which the employee must respond to the offer to hire.

8. The method of claim 7, wherein the virtual tokens of the employer are replenished upon the employer adding funds in relation to the account maintained by the system.

9. The method of claim 8, wherein the funds added in relation to the account are non-refundable and non-transferable.

10. The method of claim 9, wherein the offer to hire is for any one of a emergency position of employment, a temporary position of employment and a permanent position of employment.

11. The method of claim 10, wherein the employer and the employee are involved with a professional industry.

12. The method of claim 11, wherein the professional industry is a dental industry.

13. A method for setting up an interview with an employee using a computer-based system, comprising:
receiving from the employee employment information and contact information through a web-based interface and storing the employment information and contact information into a record in a database;
receiving a search request from an employer based on search criteria entered by the employer into a web-based search engine of the system;
providing search results from the web-based search engine to the employer based in the search, the search results including at least a portion of the employment information of the record associated with the employee, but excluding the contact information of the record associated with the employee;
permitting the employer to request an interview with the employee by so indicating in relation to the record associated with the employee in the search results, the request including sending a request for interview to the employee through a communication system associated with the computer system;
receiving from the employee an acceptance to the request for interview;
providing the employer with an indication of the acceptance to the request for interview;
providing the employer with the contact information of the record associated with the employee; and
permitting the employer to enter interview information relating to the time and place of the interview into the system, and sending the interview information to the employee through the communication system.

14. The method of claim 13, wherein the employment information and the search criteria each include: a description of the professional experience of the employee; a city of residence of the employee; languages spoken by the employee; an hourly rate of the employee; and times at which the employee is available for work.

15. The method of claim 14, further comprising;
receiving an offer to hire the employee from the employer;
providing the offer to hire to the employee; and
receiving an acceptance of the offer from the employee.

16. The method of claim 15, further comprising providing to the employee a gift certificate.

17. The method of claim 16, further comprising providing a specific time frame in which the employee must respond to the request for interview.

18. The method of claim 17, further comprising providing a specific time frame in which the employee must respond to the offer to hire.

19. The method of claim 18, wherein the offer to hire is for any one of a emergency position of employment, a temporary position of employment and a permanent position of employment.

20. The method of claim 19, wherein the employer and the employee are involved with a professional industry, and wherein the professional industry is a dental industry.
